(19) United States
(12) Patent Application Publication
(10) Pub. No.: US 2026/0361748 A1
(43) Pub. Date: Nov. 12, 2026

(54) AUTO-DEPLOYING DATA SECURITY CONTROLS VIA AUTONOMOUS PENTESTING AFTER DATA DISCOVERY

(71) Applicant: Horizon 3 AI, Inc., Dover, DE (US)

(72) Inventors: James Walter Horseman, Wesley Chapel, FL (US); Zachary Daniel Hanley, Apex, NC (US); Naveen Naga Sunkavally, Cary, NC (US); Snehal Antani, San Francisco, CA (US)

(21) Appl. No.: 19/201,254

(22) Filed: May 7, 2025

(51) Int. Cl. H04L 9/40; H04L 41/16

(52) U.S. Cl. CPC H04L 63/1433; H04L 41/16; H04L 63/0263; H04L 63/1491; H04L 63/20

(57) ABSTRACT

An autonomous pentesting agent may execute autonomous pentesting operations during an autonomous pentest on a network. The agent may perform a threat level assessment procedure on data identified during the autonomous pentest. Performing the threat level assessment procedure may include: determining a sensitivity level of the data based on metadata associated with the data and/or a content of the data; and assigning a threat level to the data based on the sensitivity level of the data and on an exploitation complexity associated with the data, where the exploitation complexity corresponds to a level of difficulty associated with exploitation of the data. The agent may deploy, as part of the autonomous pentest and in response to the threat level assessment procedure, data security mechanisms that inhibit unauthorized access to the data, where the data security mechanisms are selected based on the threat level assigned to the data.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support auto-deploying data security controls via autonomous pentesting after data discovery.

In some aspects, the techniques described herein relate to a method for deploying data security controls based on autonomous pentesting, including: executing one or more autonomous pentesting operations during an autonomous pentest on a network including a plurality of network assets; performing a threat level assessment procedure on data identified during the autonomous pentest based at least in part on the one or more autonomous pentesting operations, wherein performing the threat level assessment procedure includes: determining a sensitivity level of the data based at least in part on metadata associated with the data, a content of the data, or both; and assigning a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and deploying, as part of the autonomous pentest and in response to the threat level assessment procedure, one or more data security mechanisms that inhibit unauthorized access to the data, wherein the one or more data security mechanisms are selected based at least in part on the threat level assigned to the data.

In some aspects, the techniques described herein relate to an apparatus for deploying data security controls based on autonomous pentesting, including: one or more memories storing processor-executable code; and one or more processors coupled with the one or more memories and individually or collectively operable to execute the code to cause the apparatus to: execute one or more autonomous pentesting operations during an autonomous pentest on a network including a plurality of network assets; perform a threat level assessment procedure on data identified during the autonomous pentest based at least in part on the one or more autonomous pentesting operations, wherein, to perform the threat level assessment procedure, the one or more processors are individually or collectively further operable to execute the code to cause the apparatus to: determine a sensitivity level of the data based at least in part on metadata associated with the data, a content of the data, or both; and assign a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and deploy, as part of the autonomous pentest and in response to the threat level assessment procedure, one or more data security mechanisms that prevent inhibit unauthorized access to the data, wherein the one or more data security mechanisms are selected based at least in part on the threat level assigned to the data.

In some aspects, the techniques described herein relate to a non-transitory computer-readable medium storing code for deploying data security controls based on autonomous pentesting, the code including instructions executable by one or more processors to: execute one or more autonomous pentesting operations during an autonomous pentest on a network including a plurality of network assets; perform a threat level assessment procedure on data identified during the autonomous pentest based at least in part on the one or more autonomous pentesting operations, wherein, to perform the threat level assessment procedure, the instructions are further executable by the one or more processors to: determine a sensitivity level of the data based at least in part on metadata associated with the data, a content of the data, or both; and assign a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and deploy, as part of the autonomous pentest and in response to the threat level assessment procedure, one or more data security mechanisms that prevent inhibit unauthorized access to the data, wherein the one or more data security mechanisms are selected based at least in part on the threat level assigned to the data.

### BRIEF DESCRIPTION OF THE DRAWINGS

FIG. 1 shows an example of a computing environment that supports auto-deploying data security controls via autonomous pentesting after data discovery in accordance with aspects of the present disclosure.

FIG. 2 shows an example of an autonomous pentest map that supports auto-deploying data security controls via autonomous pentesting after data discovery in accordance with aspects of the present disclosure.

FIG. 3 shows an example of a computing environment that supports auto-deploying data security controls via autonomous pentesting after data discovery in accordance with aspects of the present disclosure.

FIGS. 4 and 5 show examples of flow diagrams that support auto-deploying data security controls via autonomous pentesting after data discovery in accordance with aspects of the present disclosure.

FIG. 6 shows a diagram of a system including a device that supports auto-deploying data security controls via autonomous pentesting after data discovery in accordance with aspects of the present disclosure.

FIG. 7 shows a flowchart illustrating methods that support auto-deploying data security controls via autonomous pentesting after data discovery in accordance with aspects of the present disclosure.

### DETAILED DESCRIPTION

In some examples, a pentest or other security assessment may identify vulnerabilities within a target network. For example, a pentest on the target network may identify and exploit vulnerabilities, revealing network assets and data that may be susceptible to attack. Other security assessments—including network scans, manual security reviews, or security policy audits—may identify exposed network assets and data, misconfigurations, or other security vulnerabilities. In some cases, pentests and other security assessments may produce reports that enumerate the identified vulnerabilities and highlight network assets and data that may be subject to compromise. However, the vulnerabilities may remain within the network, unaddressed after the pentests or other security assessments conclude. In other words, the vulnerabilities may persist in the network after identification, leaving network assets and data open to attack.

An autonomous pentesting agent described herein may manage exposed data during an autonomous pentest. That is, in addition to reporting data exposure as part of or at the conclusion of the autonomous pentest, the autonomous pentesting agent may apply data security mechanisms during the pentest and, in some examples, immediately after (or shortly after, such as while the pentesting is still running) data is discovered as being exposed. For example, the autonomous pentesting agent may identify and assess data during an autonomous pentest of a target network. Assessing the data may include determining a sensitivity level of the data and a threat level associated with the data. That is, the autonomous pentesting agent may evaluate financial, emotional, or reputational harm that may be caused if the data were to be obtained by an attacker or otherwise exposed outside of the target network or organization associated with the target network, as well as how difficult the data was to identify and/or exploit. Based on the sensitivity and accessibility (e.g., complexity of access or exploitation) of the data, the autonomous pentesting agent may assign a threat level and deploy data security mechanisms in accordance with the assigned threat level. For example, the autonomous pentesting agent may deploy data security mechanisms that inhibit, reduce, or prevent unauthorized access to the data. By deploying the data security mechanisms during the autonomous pentest—rather than after its conclusion—the autonomous pentesting agent may reduce a duration of exposure of the data to unauthorized access. Additionally, by selecting the data security mechanisms in accordance with information about the data and a context of the data obtained during pentesting, the autonomous pentesting agent may implement data security mechanisms that are more effective at inhibiting unauthorized access to the data than manually selected or configured data security mechanisms.

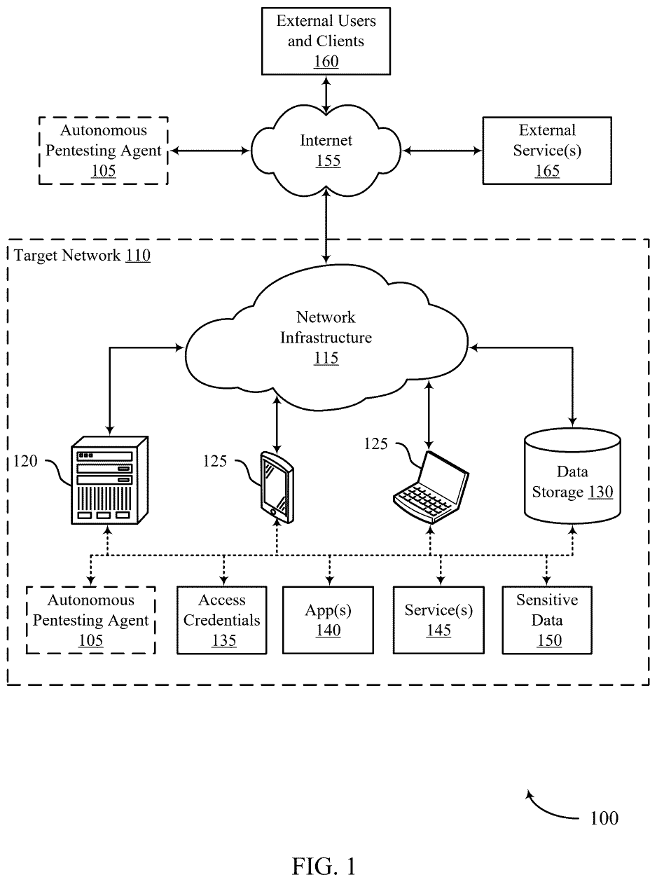

FIG. 1 illustrates an example of a computing environment 100 that supports auto-deploying data security controls via autonomous pentesting after data discovery in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and service(s) 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and service(s) 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (access credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

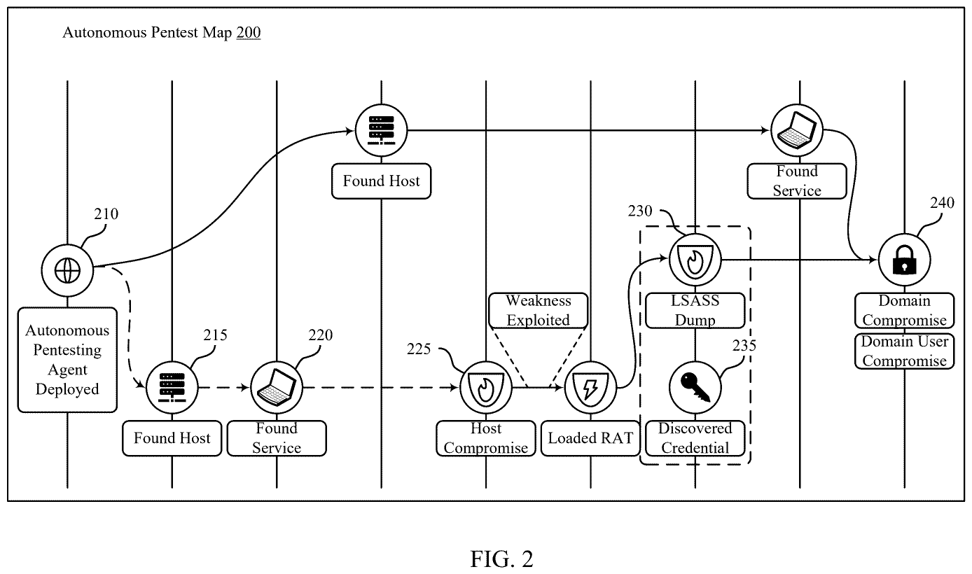

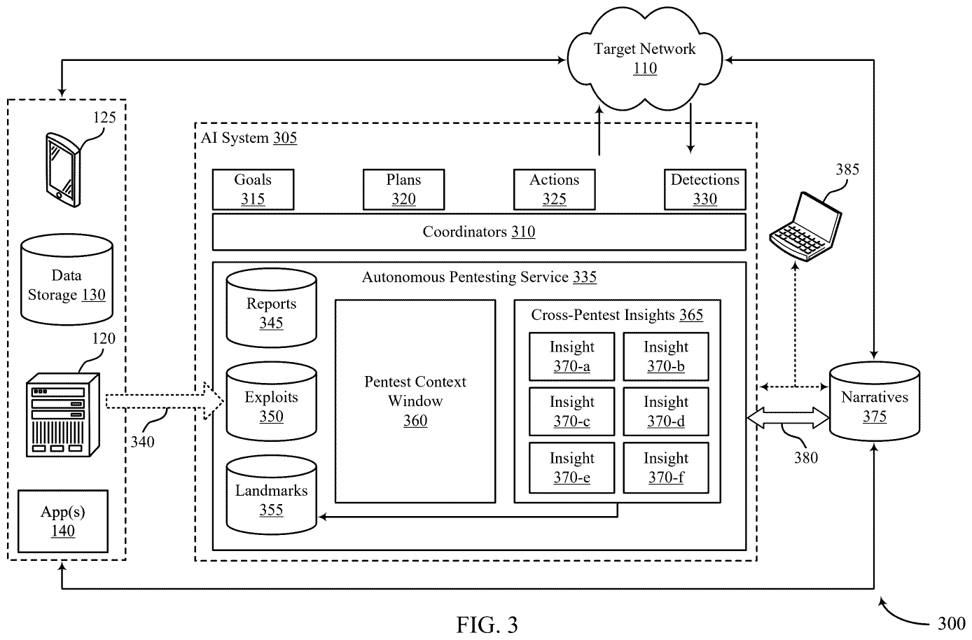

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more artificial intelligence (AI) models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, which enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may perform an autonomous pentest of the target network 110, during which the autonomous pentesting agent 105 may deploy data security mechanisms that inhibit unauthorized access to data. For example, the autonomous pentesting agent 105 may identify data during the autonomous pentest of the target network 110 by accessing network assets, including the network assets described with reference to FIG. 1. As an example, the autonomous pentesting agent 105 may compromise one or more of the computing devices 125, which may store the sensitive data 150. The autonomous pentesting agent 105 may assess a threat level—including a sensitivity level and an exploitation complexity—of the data and deploy corresponding data security mechanisms that inhibit unauthorized access (or all access including authorized access) to the data.

By deploying data security mechanisms during the autonomous pentest, the autonomous pentesting agent 105 may improve the security of the target network 110. Specifically, the autonomous pentesting agent 105 may reduce a window of opportunity for attackers by deploying data security mechanisms during a pentest of the target network 110 rather than after its conclusion. That is, some other security assessments may involve reporting, but not mitigation, of data exposures, leaving mitigation to be performed manually after assessments are complete and allowing data exposures to persist unmitigated or unaddressed. The autonomous pentesting agent 105 may address persistent data exposures that are permitted by other security assessments by implementing data security mechanisms directly after data exposures are identified (e.g., prior to subsequent pentesting operations). Additionally, the autonomous pentesting agent 105 may deploy data security mechanisms that are more effective than manually selected, configured, and deployed data security mechanisms. That is, the autonomous pentesting agent 105 may select data security mechanisms in accordance with the manner in which data was accessed during the pentest, enabling data security mechanisms to be more effective against probable attack patterns.

FIG. 2 shows an example of an autonomous pentest map 200 that supports auto-deploying data security controls via autonomous pentesting after data discovery in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support an autonomous pentest of a target network during which the autonomous pentesting service may deploy data security mechanisms. For example, the autonomous pentesting service may identify data during the autonomous pentest of the target network by accessing network assets, including via an attack path shown in the autonomous pentest map 200. As an example, the autonomous pentesting service may identify a host (e.g., at the host identification 215 event) and compromise the host (e.g., at the host compromise 225 event), enabling the autonomous pentesting service to access data on that host. The autonomous pentesting service may assess a threat level of the data on the host and deploy corresponding data security mechanisms to inhibit (e.g., prevent, limit, deny) unauthorized access to the data. In some examples, the autonomous pentesting service may deploy the data security mechanisms prior to other events in the autonomous pentest map, such as prior to loading the RAT, deploying the attacker tool 230, and/or performing the credential identification 235. Deploying the data security mechanisms prior to completion of the autonomous pentest (or prior to other operations within the autonomous pentest) may reduce the duration that data is exposed and/or vulnerable.

FIG. 3 shows an example of a computing environment 300 that supports auto-deploying data security controls via autonomous pentesting after data discovery in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service 335 may utilize the AI system 305 to deploy data security mechanisms during an autonomous pentest of the target network 110. For example, the autonomous pentesting service 335 may identify data during the autonomous pentest of the target network 110 by accessing network assets. The autonomous pentesting service 335 may assess a threat level of the data identified during the pentest and deploy corresponding data security mechanisms to inhibit unauthorized access to the data. For example, the autonomous pentesting service 335 may deploy the data security mechanisms based on a threat level assessment procedure. The autonomous pentesting service 335 may use the AI system 305 to perform this procedure. For example, the autonomous pentesting service 335 may use the AI system 305 to determine whether the data includes sensitive data, including personally identifiable information (PII), healthcare data (e.g., protected health information (PHI), such as data protected by the Health Insurance Portability and Accountability Act (HIPAA)), financial information, or other sensitive and/or regulated information.

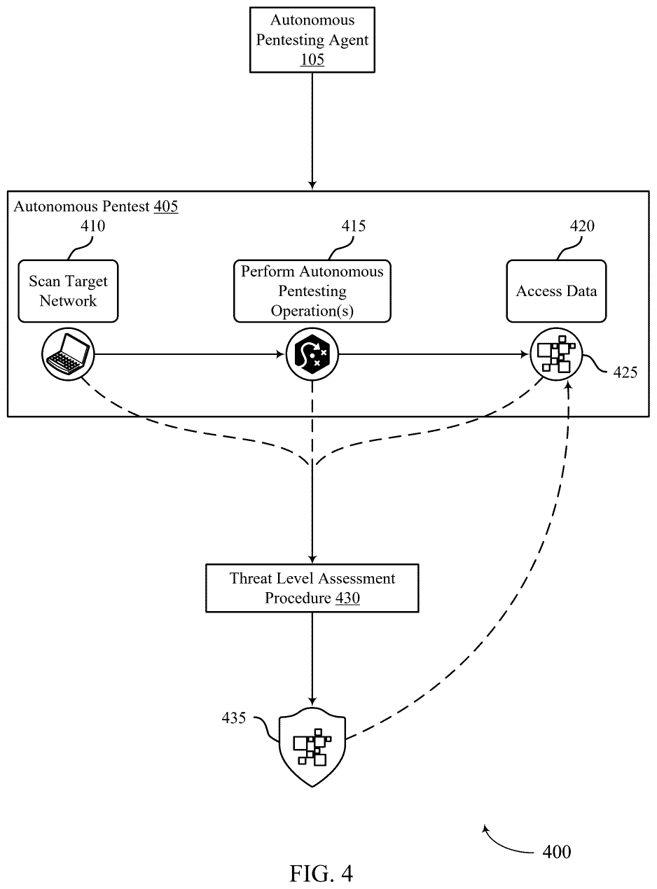

FIG. 4 shows an example of a flow diagram 400 that supports auto-deploying data security controls via autonomous pentesting after data discovery in accordance with aspects of the present disclosure. The flow diagram 400 may implement or be implemented by the computing environment 100, the autonomous pentest map 200, the computing environment 300, or any combination thereof. For example, the flow diagram 400 may illustrate an autonomous pentest 405 by an autonomous pentesting agent 105 of a target network, such as the target network 110 as described with reference to FIGS. 1 and 3.

The autonomous pentesting agent 105 may perform an autonomous pentest 405 of a target network. The autonomous pentest 405 may include, at 410, a scan of the target network. For example, the autonomous pentesting agent 105 may scan the target network and identify network assets including credentials, file shares, data storage, computing devices, or other network assets described herein, including with reference to FIG. 1. The autonomous pentesting agent 105 may then, at 415, perform autonomous pentesting operation(s). For example, the autonomous pentesting agent 105 may execute autonomous pentesting operation(s) that target vulnerabilities (e.g., common vulnerabilities and exposures (CVEs)) of network assets identified during the scan at 410.

At 420, the autonomous pentesting agent 105 may access data 425. For example, the autonomous pentesting agent 105 may gain unauthorized access to (e.g., exploit) the data 425 through the autonomous pentesting operation(s) at 415. The autonomous pentesting agent 105 may access the data by compromising a network asset that includes or has access to the data 425. As an example, the autonomous pentesting agent 105 may identify a host during the scan at 410, identify a CVE at the host, perform an exploit that targets the CVE, compromise the host, and then access the data 425 on the host. The data 425 accessed during the autonomous pentest 405 may be referred to as “exposed” data. As used herein, exposed data may refer to data that is accessible to unauthorized individuals or entities. The data 425 may be exposed due to misconfigurations of access policies, vulnerabilities of network assets that have access to the data 425, or both.

After accessing the data 425, the autonomous pentesting agent 105 may perform a threat level assessment procedure 430. The threat level assessment procedure 430 may include determining a sensitivity level of the data 425 and assigning a threat level to the data 425.

For example, the autonomous pentesting agent 105 may determine the sensitivity level of the data 425 based on metadata associated with the data 425, content of the data 425, or both. In other words, the autonomous pentesting agent 105 may identify—through metadata or content of the data 425—sensitive information in the data 425, such as PII, healthcare data (e.g., PHI or other information protected by HIPAA), financial data, or other regulated or sensitive information. The autonomous pentesting agent 105 may determine the sensitivity level of the data 425 based on financial, emotional, or reputational harm that may be caused if the data 425 were to be obtained by an unauthorized user. As an example, the autonomous pentesting agent 105 may determine a relatively high sensitivity level based on the data 425 including a Social Security Number (SSN) and a lower sensitivity level based on the data 425 including an address of a user of the target network.

The autonomous pentesting agent 105 may assign a threat level to the data 425 based on the sensitivity level and an exploitation complexity associated with the data 425. For example, the autonomous pentesting agent 105 may evaluate how easily the data 425 may be accessed (e.g., a complexity level of the autonomous pentesting operations at 415) and/or exfiltrated (e.g., exported from the target network). As an example, the autonomous pentesting agent 105 may assign a higher threat level based on the data 425 being in a publicly accessible Amazon Simple Storage Service (S3) bucket and a lower threat level based on the data 425 being in immutable cloud storage with end-to-end encryption and access controls. In another example, the autonomous pentesting agent 105 may assign a high threat level based on the data 425 being accessible via a link in which anyone with the link can view the data 425 (e.g., a SharePoint, Confluence, or Google Docs document); a medium threat level based on the data 425 being in a file share accessible to a single department within a company or organization; a medium threat level based on the data 425 being accessible to the entire company or organization in a communications platform (e.g., Slack) or a file sharing platform (e.g., SharePoint); or a low threat level based on the data 425 being accessible to relatively few employees of the company or organization (e.g., less than a threshold).

The autonomous pentesting agent 105 may perform the threat level assessment procedure 430 using one or more tools, including ML engines (e.g., the AI system 305 described with reference to FIG. 3) or other tools external to an autonomous pentesting service that includes the autonomous pentesting agent 105. For example, the autonomous pentesting agent 105 may input the data 425 and an indication of the autonomous pentesting operations (e.g., performed at 415) to an ML model. The ML model may be trained to identify sensitive data and evaluate complexity of data exploitation. In some examples, the ML model may output an indication of the sensitivity level and/or the threat level. In such examples, the ML model may be configured such that it does not retain the data 425.

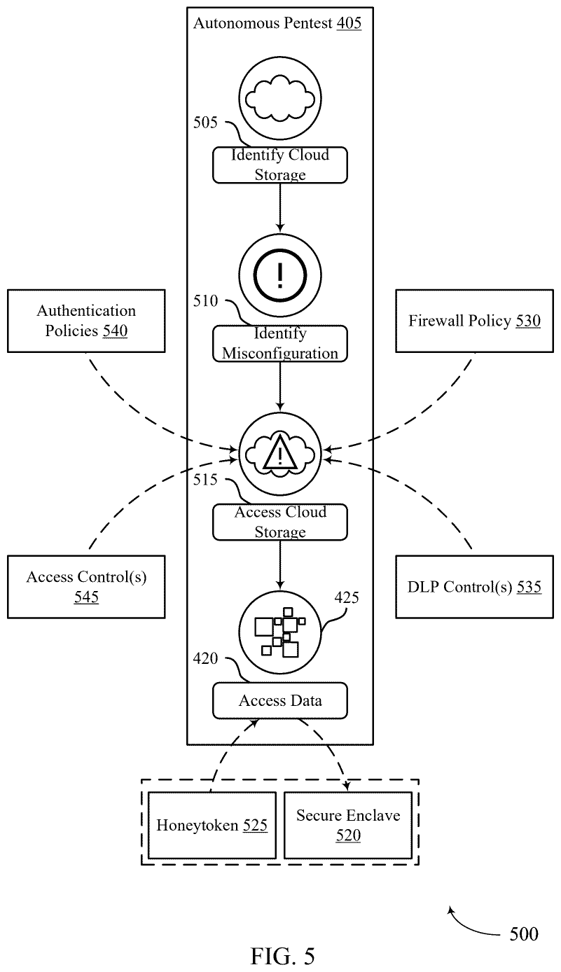

The autonomous pentesting agent 105 may deploy data security mechanisms 435 based on the threat level assessment procedure 430. For example, the autonomous pentesting agent 105 may autonomously deploy the data security mechanisms 435 in the target network during the autonomous pentest 405, where the data security mechanisms 435 are selected in accordance with the threat level assigned to the data 425. The autonomous pentesting agent 105 may select the data security mechanisms 435 based on a policy of the target network. For example, prior to the autonomous pentest 405, the autonomous pentesting agent 105 may receive one or more inputs indicating a data security policy. The data security policy may include types of data security mechanisms that are to be deployed in different cases. That is, the data security policy may include different threat levels and/or types of data (e.g., S3 buckets, credentials, file shares or databases, etc.) and corresponding data security mechanisms that are to be deployed if that threat level and/or type of data is accessed during the autonomous pentest 405. In such examples, the autonomous pentesting agent 105 may classify the data 425 into a threat level tier and deploy corresponding data security mechanisms based on the inputs indicating the data security policy. Examples of different threat levels and/or types of data and corresponding data security mechanisms may be described in greater detail elsewhere herein, including with reference to FIG. 5.

After deploying the data security mechanisms 435, the autonomous pentesting agent 105 may output an indication of the data security mechanisms 435. For example, the autonomous pentesting agent 105 may transmit an indication of the data security mechanisms 435 to a Security and Information Event Management (SIEM) or Security Orchestration, Automation, and Response (SOAR) platform associated with the target network. That is, the SIEM or SOAR platform may store record(s) of security information associated with the network, including data security mechanisms, and the autonomous pentesting agent 105 may update the SIEM or SOAR platform with the data security mechanisms 435 that were autonomously deployed during the autonomous pentest 405. Additionally, or alternatively, the autonomous pentesting agent 105 may output an indication of the data security mechanisms 435 to a user associated with the target network, such as via a user interface or dashboard of an autonomous pentesting service associated with the autonomous pentesting agent 105.

In some examples, the autonomous pentesting agent 105 may verify deployment of the data security mechanisms 435 after the autonomous pentest 405. That is, in a subsequent pentest (or subsequent pentesting operations during a same pentest), the autonomous pentesting agent 105 may perform autonomous pentesting operations that target the data 425 accessed via the autonomous pentesting operations at 415. If the autonomous pentesting agent 105 fails to access the data 425, the autonomous pentesting agent 105 may validate that the data security mechanisms 435 inhibit access to the data 425. Alternatively, if the autonomous pentesting agent 105 is able to access the data 425, the autonomous pentesting agent 105 may re-assess the threat level of the data 425 and update the data security mechanisms 435.

FIG. 5 shows an example of a flow diagram 500 that supports auto-deploying data security controls via autonomous pentesting after data discovery in accordance with aspects of the present disclosure. The flow diagram 500 may implement or be implemented by the computing environment 100, the autonomous pentest map 200, the computing environment 300, the flow diagram 400, or any combination thereof. For example, the flow diagram 500 may illustrate an example of an autonomous pentest 405 by an autonomous pentesting agent, such as the autonomous pentesting agent 105 as described with reference to FIGS. 1 and 4.

The autonomous pentest 405 may include, at 505, identifying cloud storage. For example, an autonomous pentesting agent may perform a scan of a target network subject to the autonomous pentest 405 and, through the scan, identify the cloud storage. Additionally, at 510, the autonomous pentesting agent may identify a misconfiguration at the cloud storage. For example, the autonomous pentesting agent may identify that the cloud storage is misconfigured and therefore accessible to unauthorized users. At 515, the autonomous pentesting agent may access the cloud storage using the identified misconfiguration. By accessing the cloud storage at 515, at 420, the autonomous pentesting agent may access data 425 stored in the cloud storage.

After accessing the data 425 at 420, the autonomous pentesting agent may perform a threat level assessment procedure on the data 425, such as the threat level assessment procedure 430 described with reference to FIG. 4. Based on the threat level assessment procedure, the autonomous pentesting agent may deploy one or more data security mechanisms to inhibit unauthorized access to the data 425. While the data security mechanisms described with reference to FIG. 5 are discussed in the context of data in cloud storage, it should be understood that the data security mechanisms may be applied to data stored in different contexts within a network (e.g., at computing devices, at apps or services, in other data storage components, at servers, etc.).

In some examples, a data security mechanism of the one or more data security mechanisms may include moving the data 425 to a secure enclave 520 and replacing the data 425 with a honeytoken 525 (e.g., a tripwire, a Canary Token, etc.). The honeytoken 525 may be an example of decoy data that, when accessed, is configured to transmit a notification to a user or a security team of the target network. The honeytoken 525 may mimic the data 425 identified during the autonomous pentest 405 but include no sensitive data. In other words, the autonomous pentesting agent may replace the data 425 identified during the autonomous pentest 405 with a tripwire configured to transmit an alert based on an access attempt, where the tripwire is generated in accordance with attributes of the data. The secure enclave 520 may be an example of a hardware-based, isolated environment within a microchip that protects the data 425 from unauthorized access. That is, the autonomous pentesting agent may store the data in a secure enclave 520 of a network asset of the target network, where the secure enclave 520 is isolated from a main processor of the network asset. In the example of FIG. 5, the data 425 may be a file in the cloud storage, and the autonomous pentesting agent may store the file in the secure enclave 520 while substituting a honeytoken 525 file. In other words, the autonomous pentesting agent may swap real content with monitored bait, ensuring that access attempts trigger an alarm indicating a potential attack.

In some examples, a data security mechanism of the one or more data security mechanisms may include a firewall policy 530. For example, the autonomous pentesting agent may activate the firewall policy 530 (e.g., an outbound firewall policy or rule) that prevents the transfer of the data 425 out of the target network or out of a segment of the network. For example, the autonomous pentesting agent may determine segments of the network based on operations during the autonomous pentest (e.g., based on identifying relationships between network assets, groupings of network assets, etc.) and apply the firewall policy 530 to a segment of the network that includes the data 425. Put another way, the autonomous pentesting agent may implement outbound firewall rules, segmentation, or both to impede exfiltration of the data 425.

Additionally, or alternatively, a data security mechanism of the one or more data security mechanisms may include data loss prevention (DLP) control(s) 535. For example, the autonomous pentesting agent may tag the data 425 that was compromised (e.g., accessed) during the autonomous pentest 405 and encrypt the tagged data. In other words, the autonomous pentesting agent may identify or flag data accessed during the autonomous pentest 405 and later encrypt data that is identified or flagged. Additionally, the autonomous pentesting agent may deploy the DLP control(s) 535 to prevent (e.g., inhibit) unauthorized transfer of the data 425. The DLP control(s) 535 may be configured to continuously monitor movement of the data 425 within the target network and prevent unauthorized access and/or transfer of the data 425 when detected.

A data security mechanism of the one or more data security mechanisms may include deploying authentication policies 540. For example, the autonomous pentesting agent may update the authentication policies 540 (e.g., one or more authentication policies) of an access policy associated with the cloud storage that includes the data 425. As an example, the autonomous pentesting agent may update the authentication policies 540 of the cloud storage to include multi-factor authentication (MFA). That is, the autonomous pentesting agent may configure the cloud storage to be accessible to a user after the provision of two or more authentication factors that verify an identity of the user as an authorized user (e.g., a user in a list of users permitted to access the cloud storage).

Additionally, or alternatively, a data security mechanism of the one or more data security mechanisms may include updating access control(s) 545. For example, the autonomous pentesting agent may modify or update access control(s) associated with the cloud storage, including enforcing private access (e.g., restricting traffic that includes the data 425 to be through a private network), enabling encryption, and tightening Identity and Access Management (IAM) rules (e.g., lists of users that are permitted to access the data 425).

The autonomous pentesting agent may deploy one or more of the data security mechanisms described herein. For example, the autonomous pentesting agent may deploy one or more data security mechanisms that inhibit unauthorized access to the data 425. In examples in which additional data is identified during the autonomous pentest 405, the autonomous pentesting agent may separately assess and deploy one or more data security mechanisms for that data. Put another way, for each set of data accessed during the autonomous pentest 405, the autonomous pentesting agent may deploy one or more data security mechanisms, which may include any combination of the data security mechanisms described herein.

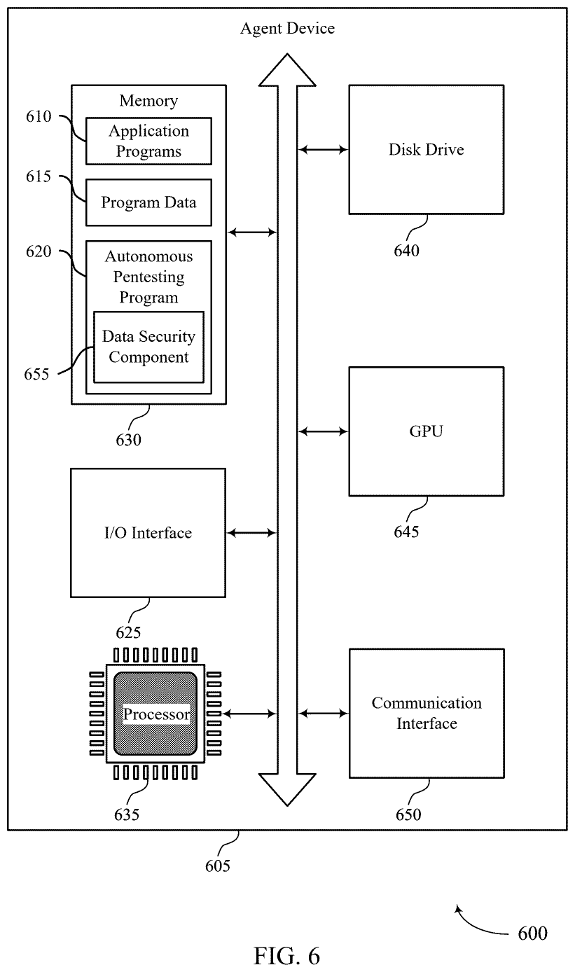

FIG. 6 shows a diagram of a system 600 including an agent device 605 that supports auto-deploying data security controls via autonomous pentesting after data discovery in accordance with aspects of the present disclosure. The agent device 605 may be an example of a device or server on which an autonomous pentesting agent 105 is deployed as described herein. The agent device 605 may include components for auto-deploying data security controls via autonomous pentesting after data discovery, such as a memory 630 including application programs 610, program data 615, an autonomous pentesting program 620, and a data security component 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting auto-deploying data security controls via autonomous pentesting after data discovery. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting auto-deploying data security controls via autonomous pentesting after data discovery). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network (e.g., a target network 110 as described herein) accessed by the agent device 605, such as accessed via the communication interface 650. That is, the autonomous pentesting program 620 may be configured to perform an autonomous pentest as described herein, including an autonomous pentest involving deploying data security controls based on autonomous pentesting.

The data security component 655 may support deploying data security controls based on autonomous pentesting in accordance with examples as disclosed herein. For example, the data security component 655 may be configured as or otherwise support a means for executing one or more autonomous pentesting operations during an autonomous pentest on a network including multiple network assets. The data security component 655 may be configured as or otherwise support a means for performing a threat level assessment procedure on data identified during the autonomous pentest based on the one or more autonomous pentesting operations. Performing the threat level assessment procedure may include determining a sensitivity level of the data based on metadata associated with the data, a content of the data, or both. Additionally, performing the threat level assessment procedure may include assigning a threat level to the data based on the sensitivity level of the data and on an exploitation complexity associated with the data, where the exploitation complexity corresponds to a level of difficulty associated with exploitation of the data based on the one or more autonomous pentesting operations. The data security component 655 may be configured as or otherwise support a means for deploying, as part of the autonomous pentest and in response to the threat level assessment procedure, one or more data security mechanisms that inhibit unauthorized access to the data, where the one or more data security mechanisms are selected based on the threat level assigned to the data.

By including or configuring the data security component 655 in accordance with examples as described herein, the agent device 605 may support techniques for improved network security.

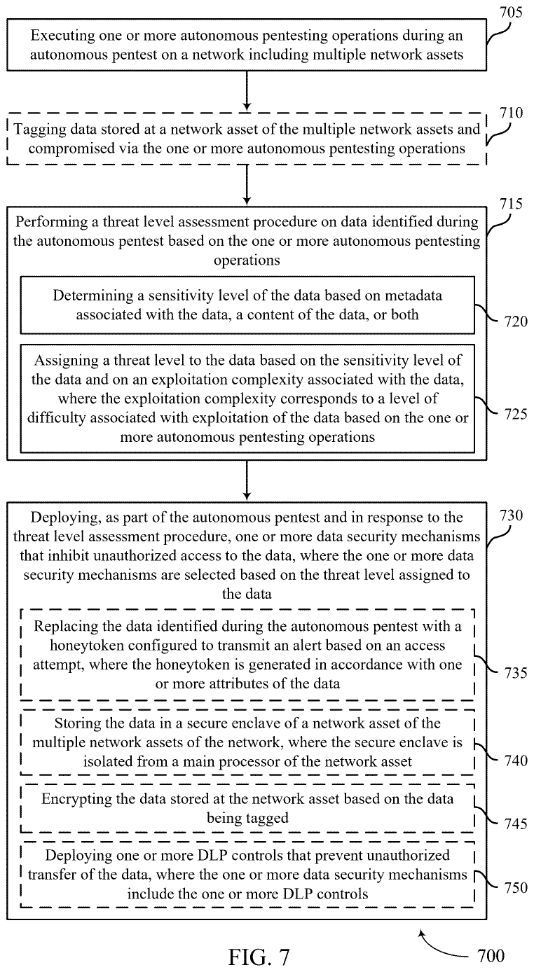

FIG. 7 shows a flowchart illustrating a method 700 that supports auto-deploying data security controls via autonomous pentesting after data discovery in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include executing one or more autonomous pentesting operations during an autonomous pentest on a network including multiple network assets.

At 710, the method 700 may include tagging data stored at a network asset of the multiple network assets and compromised via the one or more autonomous pentesting operations.

At 715, the method 700 may include performing a threat level assessment procedure on data identified during the autonomous pentest based on the one or more autonomous pentesting operations.

At 720, performing the threat level assessment procedure may include determining a sensitivity level of the data based on metadata associated with the data, a content of the data, or both.

Additionally, at 725, performing the threat level assessment procedure may include assigning a threat level to the data based on the sensitivity level of the data and on an exploitation complexity associated with the data, where the exploitation complexity corresponds to a level of difficulty associated with exploitation of the data based on the one or more autonomous pentesting operations.

At 730, the method 700 may include deploying, as part of the autonomous pentest and in response to the threat level assessment procedure, one or more data security mechanisms that inhibit unauthorized access to the data, where the one or more data security mechanisms are selected based on the threat level assigned to the data.

At 735, deploying the one or more data security mechanisms may include replacing the data identified during the autonomous pentest with a honeytoken configured to transmit an alert based on an access attempt, where the honeytoken is generated in accordance with one or more attributes of the data.

At 740, deploying the one or more data security mechanisms may include storing the data in a secure enclave of a network asset of the multiple network assets of the network, where the secure enclave is isolated from a main processor of the network asset.

At 745, deploying the one or more data security mechanisms may include encrypting the data stored at the network asset based on the data being tagged.

At 750, deploying the one or more data security mechanisms may include deploying one or more DLP controls that prevent unauthorized transfer of the data, where the one or more data security mechanisms include the one or more DLP controls.

The following provides an overview of aspects of the present disclosure:
Aspect 1: A method for deploying data security controls based on autonomous pentesting, comprising: executing one or more autonomous pentesting operations during an autonomous pentest on a network comprising a plurality of network assets; performing a threat level assessment procedure on data identified during the autonomous pentest based at least in part on the one or more autonomous pentesting operations, wherein performing the threat level assessment procedure comprises: determining a sensitivity level of the data based at least in part on metadata associated with the data, a content of the data, or both; and assigning a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and deploying, as part of the autonomous pentest and in response to the threat level assessment procedure, one or more data security mechanisms that inhibit unauthorized access to the data, wherein the one or more data security mechanisms are selected based at least in part on the threat level assigned to the data.
Aspect 2: The method of aspect 1, wherein deploying the one or more data security mechanisms comprises: replacing the data identified during the autonomous pentest with a honeytoken configured to transmit an alert based on an access attempt, wherein the honeytoken is generated in accordance with one or more attributes of the data; and storing the data in a secure enclave of a network asset of the plurality of network assets of the network, wherein the secure enclave is isolated from a main processor of the network asset.
Aspect 3: The method of any of aspects 1 through 2, further comprising: tagging data stored at a network asset of the plurality of network assets and compromised via the one or more autonomous pentesting operations; encrypting the data stored at the network asset based at least in part on the data being tagged; and deploying one or more DLP controls that prevent unauthorized transfer of the data, wherein the one or more data security mechanisms comprise the one or more DLP controls.
Aspect 4: The method of any of aspects 1 through 3, wherein deploying the one or more data security mechanisms comprises: activating an outbound firewall policy that prevents transfer of the data out of the network or out of a segment of the network.
Aspect 5: The method of any of aspects 1 through 4, further comprising: determining a plurality of segments of the network based at least in part on the one or more autonomous pentesting operations, wherein the outbound firewall policy prevents transfer of the data out of the segment of the plurality of segments of the network.
Aspect 6: The method of any of aspects 1 through 5, wherein deploying the one or more data security mechanisms comprises: updating one or more authentication policies of an access policy associated with a file share or database that includes the data based at least in part on the threat level assessment procedure.
Aspect 7: The method of any of aspects 1 through 6, further comprising: accessing, during the autonomous pentest, the data via a public network, wherein the threat level assessment procedure is performed in accordance with the data being accessible via the public network, and wherein the one or more data security mechanisms are deployed prior to one or more subsequent autonomous pentesting operations of the autonomous pentest.
Aspect 8: The method of any of aspects 1 through 7, wherein executing the one or more autonomous pentesting operations comprises: performing a scan of the network, wherein the scan identifies one or more of: one or more externally-exposed credentials or file shares, one or more misconfigurations associated with data storage of the network, one or more IOCs indicative of an attack on the network, and wherein the data is identified during the autonomous pentest via the scan.
Aspect 9: The method of any of aspects 1 through 8, further comprising: receiving one or more inputs indicative of one or more data security mechanism tiers corresponding to one or more threat level tiers, wherein performing the threat level assessment procedure comprises: classifying the data into a threat level tier of the one or more threat level tiers, wherein the one or more data security mechanisms correspond to a data security mechanism tier of the one or more data security mechanism tiers associated with the threat level tier.
Aspect 10: The method of any of aspects 1 through 9, wherein performing the threat level assessment procedure comprises: inputting the metadata associated with the data, the content of the data, or both and an indication of the one or more autonomous pentesting operations to one or more ML models, wherein the sensitivity level of the data is determined, the threat level is assigned, or both based at least in part on an output of the one or more ML models.
Aspect 11: The method of any of aspects 1 through 10, further comprising: executing one or more second autonomous pentesting operations during a second autonomous pentest on the network, wherein the one or more second autonomous pentesting operations verify whether the one or more data security mechanisms inhibit the unauthorized access to the data.
Aspect 12: The method of any of aspects 1 through 11, wherein the one or more data security mechanisms prevent access to the data via an external network, encrypt the data, modify one or more IAM policies, or any combination thereof.
Aspect 13: The method of any of aspects 1 through 12, wherein the data comprises PII, healthcare data, financial documents, regulated data, or any combination thereof.
Aspect 14: The method of any of aspects 1 through 13, wherein the exploitation complexity associated with the data is based at least in part on a quantity of operations associated with accessing the data, a complexity of the quantity of operations, a location of the data within the network, or any combination thereof.
Aspect 15: An apparatus for deploying data security controls based on autonomous pentesting, comprising: one or more memories storing processor-executable code; and one or more processors coupled with the one or more memories and individually or collectively operable to execute the code to cause the apparatus to perform a method of any of aspects 1 through 14.
Aspect 16: A non-transitory computer-readable medium storing code for deploying data security controls based on autonomous pentesting, the code comprising instructions executable by one or more processors to perform a method of any of aspects 1 through 14.
Aspect 17: An apparatus for deploying data security controls based on autonomous pentesting, comprising at least one means for performing a method of any aspects 1 through 14.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for deploying data security controls based on autonomous pentesting, comprising:
executing one or more autonomous pentesting operations during an autonomous pentest on a network comprising a plurality of network assets;
performing a threat level assessment procedure on data identified during the autonomous pentest based at least in part on the one or more autonomous pentesting operations, wherein performing the threat level assessment procedure comprises:
determining a sensitivity level of the data based at least in part on metadata associated with the data, a content of the data, or both; and
assigning a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and
deploying, as part of the autonomous pentest and in response to the threat level assessment procedure, one or more data security mechanisms that inhibit unauthorized access to the data, wherein the one or more data security mechanisms are selected based at least in part on the threat level assigned to the data.

2. The method of claim 1, wherein deploying the one or more data security mechanisms comprises:
replacing the data identified during the autonomous pentest with a honeytoken configured to transmit an alert based on an access attempt, wherein the honeytoken is generated in accordance with one or more attributes of the data; and
storing the data in a secure enclave of a network asset of the plurality of network assets of the network, wherein the secure enclave is isolated from a main processor of the network asset.

3. The method of claim 1, further comprising:
tagging data stored at a network asset of the plurality of network assets and compromised via the one or more autonomous pentesting operations;
encrypting the data stored at the network asset based at least in part on the data being tagged; and
deploying one or more data loss prevention (DLP) controls that prevent unauthorized transfer of the data, wherein the one or more data security mechanisms comprise the one or more DLP controls.

4. The method of claim 1, wherein deploying the one or more data security mechanisms comprises:
activating an outbound firewall policy that prevents transfer of the data out of the network or out of a segment of the network.

5. The method of claim 4, further comprising:
determining a plurality of segments of the network based at least in part on the one or more autonomous pentesting operations, wherein the outbound firewall policy prevents transfer of the data out of the segment of the plurality of segments of the network.

6. The method of claim 1, wherein deploying the one or more data security mechanisms comprises:
updating one or more authentication policies of an access policy associated with a file share or database that includes the data based at least in part on the threat level assessment procedure.

7. The method of claim 1, further comprising:
accessing, during the autonomous pentest, the data via a public network, wherein the threat level assessment procedure is performed in accordance with the data being accessible via the public network, and wherein the one or more data security mechanisms are deployed prior to one or more subsequent autonomous pentesting operations of the autonomous pentest.

8. The method of claim 1, wherein executing the one or more autonomous pentesting operations comprises:
performing a scan of the network, wherein the scan identifies one or more of: one or more externally-exposed credentials or file shares, one or more misconfigurations associated with data storage of the network, one or more indicators of compromise (IOCs) indicative of an attack on the network, and wherein the data is identified during the autonomous pentest via the scan.

9. The method of claim 1, further comprising:
receiving one or more inputs indicative of one or more data security mechanism tiers corresponding to one or more threat level tiers, wherein performing the threat level assessment procedure comprises:
classifying the data into a threat level tier of the one or more threat level tiers, wherein the one or more data security mechanisms correspond to a data security mechanism tier of the one or more data security mechanism tiers associated with the threat level tier.

10. The method of claim 1, wherein performing the threat level assessment procedure comprises:
inputting the metadata associated with the data, the content of the data, or both and an indication of the one or more autonomous pentesting operations to one or more machine learning (ML) models, wherein the sensitivity level of the data is determined, the threat level is assigned, or both based at least in part on an output of the one or more ML models.

11. The method of claim 1, further comprising:
executing one or more second autonomous pentesting operations during a second autonomous pentest on the network, wherein the one or more second autonomous pentesting operations verify whether the one or more data security mechanisms inhibit the unauthorized access to the data.

12. The method of claim 1, wherein the one or more data security mechanisms prevent access to the data via an external network, encrypt the data, modify one or more Identity and Access Management (IAM) policies, or any combination thereof.

13. The method of claim 1, wherein the data comprises personally identifiable information (PII), healthcare data, financial documents, regulated data, or any combination thereof.

14. The method of claim 1, wherein the exploitation complexity associated with the data is based at least in part on a quantity of operations associated with accessing the data, a complexity of the quantity of operations, a location of the data within the network, or any combination thereof.

15. An apparatus for deploying data security controls based on autonomous pentesting, comprising:
one or more memories storing processor-executable code; and
one or more processors coupled with the one or more memories and individually or collectively operable to execute the code to cause the apparatus to:
execute one or more autonomous pentesting operations during an autonomous pentest on a network comprising a plurality of network assets;
perform a threat level assessment procedure on data identified during the autonomous pentest based at least in part on the one or more autonomous pentesting operations, wherein, to perform the threat level assessment procedure, the one or more processors are individually or collectively further operable to execute the code to cause the apparatus to:
determine a sensitivity level of the data based at least in part on metadata associated with the data, a content of the data, or both; and
assign a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and
deploy, as part of the autonomous pentest and in response to the threat level assessment procedure, one or more data security mechanisms that prevent inhibit unauthorized access to the data, wherein the one or more data security mechanisms are selected based at least in part on the threat level assigned to the data.

16. The apparatus of claim 15, wherein, to deploy the one or more data security mechanisms, the one or more processors are individually or collectively further operable to execute the code to cause the apparatus to:
replace the data identified during the autonomous pentest with a honeytoken configured to transmit an alert based on an access attempt, wherein the honeytoken is generated in accordance with one or more attributes of the data; and
store the data in a secure enclave of a network asset of the plurality of network assets of the network, wherein the secure enclave is isolated from a main processor of the network asset.

17. The apparatus of claim 15, wherein the one or more processors are individually or collectively further operable to execute the code to cause the apparatus to:
tag data stored at a network asset of the plurality of network assets and compromised via the one or more autonomous pentesting operations;
encrypt the data stored at the network asset based at least in part on the data being tagged; and
deploy one or more data loss prevention (DLP) controls that prevent unauthorized transfer of the data, wherein the one or more data security mechanisms comprise the one or more DLP controls.

18. A non-transitory computer-readable medium storing code for deploying data security controls based on autonomous pentesting, the code comprising instructions executable by one or more processors to:
execute one or more autonomous pentesting operations during an autonomous pentest on a network comprising a plurality of network assets;
perform a threat level assessment procedure on data identified during the autonomous pentest based at least in part on the one or more autonomous pentesting operations, wherein, to perform the threat level assessment procedure, the instructions are further executable by the one or more processors to:
determine a sensitivity level of the data based at least in part on metadata associated with the data, a content of the data, or both; and
assign a threat level to the data based at least in part on the sensitivity level of the data and on an exploitation complexity associated with the data, wherein the exploitation complexity corresponds to a level of difficulty associated with exploitation of the data based at least in part on the one or more autonomous pentesting operations; and
deploy, as part of the autonomous pentest and in response to the threat level assessment procedure, one or more data security mechanisms that prevent inhibit unauthorized access to the data, wherein the one or more data security mechanisms are selected based at least in part on the threat level assigned to the data.

19. The non-transitory computer-readable medium of claim 18, wherein, to deploy the one or more data security mechanisms, the instructions are further executable by the one or more processors to:
replace the data identified during the autonomous pentest with a honeytoken configured to transmit an alert based on an access attempt, wherein the honeytoken is generated in accordance with one or more attributes of the data; and
store the data in a secure enclave of a network asset of the plurality of network assets of the network, wherein the secure enclave is isolated from a main processor of the network asset.

20. The non-transitory computer-readable medium of claim 18, wherein the instructions are further executable by the one or more processors to:
tag data stored at a network asset of the plurality of network assets and compromised via the one or more autonomous pentesting operations;
encrypt the data stored at the network asset based at least in part on the data being tagged; and
deploy one or more data loss prevention (DLP) controls that prevent unauthorized transfer of the data, wherein the one or more data security mechanisms comprise the one or more DLP controls.
